(19) United States
(12) Patent Application Publication
(10) Pub. No.: US 2021/0138781 A1
(43) Pub. Date: May 13, 2021

(54) LAYERED ASSEMBLY FOR REFLECTIVE PRODUCT

(71) Applicant: Jancik Arts International, Inc., Atlanta, GA (US)

(72) Inventors: Angelique Jackson, Atlanta, GA (US); Pierre-Henri Andre Thiault, Decatur, GA (US); Martin Terry, Hampton, GA (US); Gary Martin Bannister, Atlanta, GA (US)

(73) Assignee: Jancik Arts International, Inc., Atlanta, GA (US)

(21) Appl. No.: 17/096,078

(22) Filed: Nov. 12, 2020

Related U.S. Application Data
(60) Provisional application No. 62/934,777, filed on Nov. 13, 2019.

(51) Int. Cl. B32B 38/00; B32B 27/08

(52) U.S. Cl. CPC B32B 38/145; B32B 27/08; B32B 2307/4023; B32B 2307/416; B32B 2307/412

(57) ABSTRACT

Example aspects of a layered assembly for a reflective product and a method for forming a layered assembly for a reflective product are disclosed. The layered assembly for a reflective product can comprise a substrate layer; a reflective laminate layer adhered to the substrate layer; an ink layer printed on the reflective laminate layer; and, in some implementations, a protective laminate layer adhered to the ink layer.

### CROSS REFERENCE TO RELATED APPLICATION

This application claims the benefit of U.S. Provisional Application Ser. No. 62/934,777, which was filed on Nov. 13, 2019, the entirety of which is incorporated herein by reference.

### TECHNICAL FIELD

This disclosure relates to reflective products. More specifically, this disclosure relates to a reflective product comprising a layered assembly.

### BACKGROUND

Mirrors are reflective products typically comprising a sheet of glass covered with a layer of reflective silver or aluminum. Mirrors comprising glass sheets can be heavy and expensive to produce.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a layered assembly for a reflective product comprising a substrate layer; a reflective laminate layer adhered to the substrate layer; and an ink layer printed on the reflective laminate layer. In some implementations, the layered assembly further comprises a protective laminate layer adhered to the ink layer; the protective laminate layer is an optically transparent plastic film.

Also disclosed is a method for forming a layered assembly for a reflective product, the method comprising adhering a reflective laminate layer to a first substrate side of a substrate layer; and printing an ink layer onto a first reflective laminate side of the reflective laminate layer. In some implementations, the method further comprises the step of adhering a protective laminate layer to the ink layer.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and components of the following figures are illustrated to emphasize the general principles of the present disclosure. Corresponding features and components throughout the figures may be designated by matching reference characters for the sake of consistency and clarity.

FIG. 1 is a detailed cross-sectional view of a layered assembly for a reflective product comprising a substrate layer, a reflective laminate layer, an ink layer, and a protective laminate layer, in accordance with one aspect of the present disclosure.

FIG. 2 is a top perspective view of the reflective laminate layer of FIG. 1 adhered to the substrate layer of FIG. 1.

FIG. 3 is a top perspective view of a printing machine printing the ink layer of FIG. 1 onto the reflective laminate layer of FIG. 1.

FIG. 4 is a top perspective view of the ink layer of FIG. 1 printed on the reflective laminate layer of FIG. 1.

FIG. 5 is a top perspective view of a laminating machine adhering the protective laminate layer of FIG. 1 to the ink layer of FIG. 1.

FIG. 6 is a top perspective view of the layered assembly of FIG. 1 as viewed from a first position.

FIG. 7 is a top perspective view of the layered assembly of FIG. 1 as viewed from a second position.

FIG. 8 is an enlarged side view of a portion of an example ink layer comprising a plurality of separate ink droplets, in accordance with one aspect of the present disclosure. The substrate layer normally positioned underneath the reflective laminate layer has been omitted for the sake of clarity.

FIG. 9 is an enlarged top view of a portion of another example ink layer comprising a plurality of separate ink droplets, in accordance with one aspect of the present disclosure. The reflective laminate layer and substrate layer have been omitted for the sake of clarity.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed in the present application is a layered assembly for a reflective product and associated methods, systems, devices, and various apparatus. Example aspects of the layered assembly can comprise a substrate layer, a reflective laminate layer, an ink layer, and, in some implementations, a protective laminate layer. It would be understood by one of skill in the art that the disclosed layered assembly for a reflective product is described in but a few exemplary aspects among many. No particular terminology or description should be considered limiting on the disclosure or the scope of any claims issuing therefrom.

FIG. 1 illustrates a first aspect of a layered assembly 100 for a reflective product 500 (shown in FIG. 5), according to the present disclosure. Example aspects of the reflective product 500 can be a decorative mirror 510 (shown in FIG. 5), for example, or any other type of reflective product. Example aspects of the layered assembly 100 can define a reflective side 102 and an opposite non-reflective side 104. As shown, example aspects of the layered assembly 100 can comprise a base layer, which can be a substrate layer 110, for example. The substrate layer 110 can define a first substrate side 112 and an opposite second substrate side 114. According to example aspects, the substrate layer 110 can comprise any suitable material, and in particular a non-glass material, such as, for example, a Dibond® material or similar material. In one aspect, the Dibond® material can comprise a first and second aluminum laminate layer, each defining about a 0.15″ thickness (or any other suitable thickness), and a composite polyethylene core received between the first and second aluminum laminate layers. The Dibond® material can define a 3 mm thickness, a 6 mm thickness, or any other suitable thickness. In another aspect, the substrate layer 110 can comprise a sheet of plywood defining about a ½″ thickness, a ¾″ thickness, a 1″ thickness, or any other suitable thickness. The sheet of plywood can be painted on one side, both sides, or can be unpainted. In still other aspects, the substrate layer 110 can comprise painted medium density fiberboard or unpainted medium density fiberboard defining any suitable thickness. Other aspects of the substrate layer 110 can comprise a sheet of aluminum, polyvinyl chloride (PVC), corrugated plastic, polystyrene, polycarbonate, or acrylic, and can define any suitable thickness. For example, an aluminum sheet may define about a 0.04″ or 0.08″ thickness, a PVC sheet may define about a 3 mm or 6 mm thickness, a corrugated plastic sheet may define about a 4 mm or a 10 mm thickness, a polystyrene sheet may define about a 0.06″ thickness, a polycarbonate sheet may define about a 0.177″ thickness, and an acrylic sheet may define about a 0.177″ or 0.250″ thickness. In other aspects, the substrate layer 110 can be a MAX-metal™ aluminum composite panel defining a 3 mm thickness, a 6 mm thickness, or any other suitable thickness. Another aspect of the substrate layer 110 may comprise an AlumaCorr™ panel defining a 5 mm thickness or any other suitable thickness.

As shown, the layered assembly 100 can further comprise a reflective laminate layer 120 that can be adhered to the substrate layer 110. In example aspects, the reflective laminate layer 120 can define a first reflective laminate side 122 and a second reflective laminate side 124, and the second reflective laminate side 124 can be adhered to the first substrate side 112 of the substrate layer 110. According to example aspects, the reflective laminate layer 120 can comprise a reflective film or reflective vinyl. For example, in one aspect, the reflective laminate layer 120 can comprise an Oracal® silver vinyl, an Oracal® chrome vinyl, or an Oracal® gold vinyl. In another aspect, the reflective laminate layer 120 can comprise a chrome, silver, or gold reflective film. In still another aspect, wherein the substrate layer 110 is a Dibond® material, as described above, the reflective laminate layer 120 can be one of the first and second aluminum laminate layers. Example aspects of the reflective laminate layer 120 can comprise a metal material having reflective properties, such as, for example, aluminum, silver, copper, steel, gold, and the like, which can allow the reflective laminate layer 120 to reflect light in a manner similar to a mirror. Preferred aspects of the reflective laminate layer 120 comprise a reflective material having a reflectivity of about 87% or higher for visible light. The reflective laminate layer 120 can be adhered to the substrate layer 110 by a fastener, such as, for example, an adhesive, or any other suitable fastener. In some aspects, the reflective laminate layer 120 can be applied to the substrate layer 110 by a laminating machine, such as a cold laminating machine or thermal laminating machine. An example aspect of a laminating machine 410 is shown in FIGS. 4 and 5.

Example aspects of the layered assembly 100 can further comprise an ink layer 130 that can be printed on the first reflective laminate side 122, opposite from the substrate layer 110. The ink layer 130 comprises a plurality of ink droplets 810. Each ink droplet 810 has the general shape of a dome (shown in FIGS. 8 and 9), this adds texture to the ink layer 130 and, in some aspects, creates an embossed appearance. Further, the ink droplets 810 are translucid and thereby cause light reflecting off the underlying first reflective laminate side 122 to diffuse as it passes through the ink droplets 810 of the ink layer 130. In this way, the iridescent effect of the layered assembly 100 is created (shown in FIGS. 6 and 7). In some aspects, the ink layer 130 can be formed with an ultraviolet (UV) curable ink (e.g., Cannon UVgel inks). In other aspects, the ink layer 130 can be formed with solvent ink or any other suitable type of ink. Example aspects of the ink layer 130 can be printed directly onto the reflective laminate layer 120 by a printing machine 310 (shown in FIG. 3). The ink layer 130 can form various indicia 330 (shown in FIG. 3), which can include, for example, words, graphics, artistic designs, and the like. Example aspects of the ink layer 130 may or may not fully cover the first reflective laminate side 122 of the reflective laminate layer 120.

According to example aspects, the layered assembly 100 can further comprise a protective layer, such as a protective laminate layer 140. The protective laminate layer 140 can define a first protective laminate side 142 and an opposite second protective laminate side 144. The second protective laminate side 144 can be adhered to the ink layer 130. In some aspects, the second protective laminate side 144 of the protective laminate layer 140 may also be adhered to uncovered regions 322 (shown in FIG. 3) of the first reflective laminate side 122 of the reflective laminate layer 120 that are not covered by the ink layer 130. The protective laminate layer 140 can be adhered to the ink layer 130 (and in some cases, the reflective laminate layer 120) by a fastener, such as, for example, an adhesive. In other aspects, any other suitable fastener can adhere the protective laminate layer 140 to the ink layer 130. Furthermore, according to example aspects, the protective laminate layer 140 can be applied to the ink layer 130 by the laminating machine 410, as shown in FIGS. 4 and 5. Example aspects of the protective laminate layer 140 can comprise an optically transparent plastic film, such as, for example, polyethylene terephthalate (PET) film, or any other suitable film known in the art. The protective laminate layer 140 can be cold rolled or hot rolled. In a specific example aspect, the protective laminate layer 140 can be a Kimoto Glasstect film. It is important to note that, if a protective laminate layer 140 is applied to the layered assembly 100 it should not be a spray coating, or other liquid coating. Such coatings can fill gaps between ink droplets 810 of the ink layer 130 and negate the iridescence of the layered assembly 100.

FIGS. 2-5 illustrate various steps in forming the layered assembly. Referring to FIG. 2, the second reflective laminate side 124 (shown in FIG. 1) of the reflective laminate layer 120 has been adhered to the first substrate side 112 (shown in FIG. 1) of the substrate layer 110. FIG. 3 illustrates the printing machine 310 printing the indicia 330 of the ink layer 130 onto the first reflective laminate side 122 of the reflective laminate layer 120. As shown, the ink layer 130 may not fully cover the first reflective laminate side 122, resulting in the uncovered regions 322. FIGS. 4 and 5 illustrate the laminating machine 410 adhering the, optional, protective laminate layer 140 to the ink layer 130 and to the uncovered regions 322 of the first reflective laminate side 122. FIG. 5 illustrates the completed reflective product 500 comprising the layered assembly 100 exiting the laminating machine 410. As shown in the depicted aspect, the reflective product 500 can be the decorative mirror 510.

As such, a method for forming the layered assembly 100 for the reflective product 500 can comprise adhering the reflective laminate layer 120 to the first substrate side 112 of the substrate layer 110, printing the ink layer 130 onto the first reflective laminate side 122 of the reflective laminate layer 120, and, in some implementations, adhering the protective laminate layer 140 to the ink layer 130.

According to example aspects, when a stationary light source reflects off of the reflective side 102 of the layered assembly 100, the appearance of the reflective side 102 can surprisingly vary dependent upon a viewer's sight line. In one aspect, the reflective side 102 can have an iridescent quality, wherein the colors shown appear to change depending upon the angle from which the reflective side 102 is viewed. For example, as shown in FIG. 6, if a viewer (not shown) stands in a first position relative to the reflective product 500, the reflective side 102 of the layered assembly 100 can have a first appearance 610. As shown in FIG. 7, when the viewer moves to a second position relative to the reflective product 500 (for example, the viewer may move laterally in a right or left direction relative to the reflective product 500), the reflective side 102 of the layered assembly 100 can have a second appearance 710 that can be different from the first appearance 610 (shown in FIG. 6).

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A layered assembly for a reflective product comprising:
a substrate layer;
a reflective laminate layer adhered to the substrate layer; and
an ink layer printed on the reflective laminate layer.

2. The layered assembly of claim 1, wherein the ink layer comprises a plurality of ink droplets, each ink droplet has the general shape of a dome.

3. The layered assembly of claim 2, wherein one or more ink droplets of the ink layer are translucid.

4. A layered assembly for a reflective product comprising:
a substrate layer;
a reflective laminate layer adhered to the substrate layer;
an ink layer printed on the reflective laminate layer; and
a protective laminate layer adhered to the ink layer;
wherein the protective laminate layer is an optically transparent plastic film.

5. The layered assembly of claim 4, wherein the ink layer comprises a plurality of ink droplets, each ink droplet has the general shape of a dome.

6. The layered assembly of claim 5, wherein one or more ink droplets of the ink layer are translucid.

7. A method for forming a layered assembly for a reflective product comprising:
adhering a reflective laminate layer to a first substrate side of a substrate layer; and
printing an ink layer comprising a plurality of ink droplets onto a first reflective laminate side of the reflective laminate layer.

8. The method of claim 7, further comprising the step of adhering a protective laminate layer comprising an optically transparent plastic film to the ink layer.
